(19) United States
(12) Patent Application Publication
(10) Pub. No.: US 2008/0122994 A1
(43) Pub. Date: May 29, 2008

(54) LCD based communicator system

(75) Inventor: Andrei Cernasov, Ringwood, NJ (US)

Correspondence Address: Kurt Luther;HONEYWELL INTERNATIONAL INC., Law Department AB 2, P.O. Box 2245, Morristown, NJ, 07962-9806, US

(73) Assignee: HONEYWELL INTERNATIONAL INC.

(21) Appl. No.: 11/604,733

(22) Filed: Nov. 28, 2006

(51) Int. Cl. G02F 1/1333; G02F 1/13

(52) U.S. Cl. 349/1; 349/116; 349/69

(57) ABSTRACT

A liquid crystal display (LCD) based communication device (100) is designed to transmit and/or receive data via optical communication signals passing through the liquid crystal (LC) layer (20). To perform data transmission, one or more optical transmitter light sources (80) may be implemented within the LCD stack (e.g., in the backlight cavity) of the device, for transmitting data-encoded optical communication signals through the LC layer. To operate as a data receiver, one or more light sensing devices (90) may be implemented in the LCD stack to sense optical communication signals entering the device through the LC layer.

### FIELD OF THE INVENTION

The present invention relates to backlit liquid crystal display (LCD) panels, and more particularly, to LCD panels incorporating data communication functionality.

### BACKGROUND OF THE INVENTION

The primary function of conventional liquid crystal display (LCD) devices is to deliver visual information directly to one or more users, specifically, by displaying images.

The configuration of a typical LCD device is illustrated in FIGS. 1A and 1B. As shown in FIG. 1A, a typical LCD device 1 includes a liquid crystal (LC) layer 20 sandwiched between two polarizing filters 30A and 30B (hereafter “polarizers”). The LC layer is protected by a transparent front protective sheet 10, e.g., a glass plate. For a backlit LCD device 1, behind the LC and polarizing layers are a light diffusing film 40 (hereafter “diffuser”), a backlight source 50, and a reflective surface 60. However, in a reflective-type LCD device 1, the diffuser 40 and backlight source 50 would be omitted (thus, these layers are illustrated by dotted lines in FIG. 1A). A casing or enclosure 70 is provided to hold the aforementioned layers in place. FIG. 1B illustrates an exploded view of the stack of LCD layers described above. The specification may collectively refer to these layers as the “LCD stack” of a backlit LCD device (including diffuser 40 and backlight source 50) or a reflective-type LCD device (without diffuser 40 or backlight source 50).

In a typical backlit LCD device 1 (also referred to as a “transmissive” LCD device), the backlight is emitted directly from source 50 through the diffuser 40 toward the LC layer 20. The diffuser 40 diffuses the backlight light to make the intensity or brightness more uniform across the LCD.

FIGS. 2A and 2B illustrate one arrangement of backlight sources 50 that can be implemented in a typical backlit LCD device. FIG. 2A illustrates a side view of a backlit LCD device 1, while FIG. 2B shows a cross-sectional view at CV. The arrangement in FIGS. 2A and 2B is generally referred to as an LED edge-lit light guide assembly. It includes a combination of “pinpoint” light sources 52, specifically, light-emitting diodes (LEDs). The LEDs 52 are configured to emit into a light guide/diffuser 44. Such an arrangement may optionally include cold cathode fluorescent lamps (CCFLs) (not shown) and/or an additional light-diffusing sheet (not shown).

However, other backlight arrangements are available, an example of which is shown in FIGS. 3A and 3B. Particularly, FIGS. 3A and 3B illustrate a side and perspective view, respectively, of an LCD stack in which a backlight panel is formed by mounting a plurality of LEDs 56 onto a reflective layer 60. With daylight visibility becoming a common requirement for LCD devices 1, the luminosity of the LCD image routinely exceeds 1000 Nits. LEDs can easily provide the necessary illumination levels. Another advantage of LEDs is that they are easy to control and modulate.

Furthermore, an alternative to backlit LCD devices are reflective-type LCDs. In a reflective-type LCD device, the LC layer 20 is illuminated by external light, rather than an internal source. Referring again to FIGS. 1A and 1B, after passing through the LC layer 20 and polarizers 30A and 30B, the external light is diffused (optional) and reflected back toward the viewer by the reflective surface 60. In such devices, the cells in the LC layer 20 are driven by electrodes (not shown) to selectively allow light to pass through in order to display images.

Critical to the operation of both backlit and reflective-type LCDs is the fact that they act as light valves, i.e., optical devices that vary the amount of light that reaches the target. Thus, as is true with other types of light valves, LCDs are capable of bidirectional control of the passage of light. However, conventional LCD systems fail to exploit this aspect.

### SUMMARY OF THE INVENTION

Exemplary embodiments of the present invention are directed to a liquid crystal display (LCD) device that, using the bidirectional nature of the liquid crystal (LC) layer, is capable of performing one or more communication functions. To accomplish this, the infrastructure of the LCD device is configured to transmit and/or receive optical communication signals through the LC layer.

According to an exemplary embodiment, the LCD device is capable of functioning as an optical data receiver. In such an embodiment, the LCD device may include at least one light sensor within the LCD stack for sensing external optical communication signals received through the LC layer. The light sensor(s) may be operably connected to a communications controller, which is capable of extracting data from sensed signals. Furthermore, the LCD device may include other elements of an optical transceiver, such as a demodulator for demodulating the sensed signals.

According to another exemplary embodiment of the present invention, the LCD device is capable of functioning as an optical data transmitter. As such, the LCD device may include one or more optical transmitters within the LCD stack, which are configured to transmit optical communication signals through the LC layer. In this embodiment, the optical transmitter(s) may be operably connected to a communications controller for encoding data into the optical signals to be transmitted through the LC layer. For instance, a modulator may be provided for modulating the optical signals, under the control of the communications controller, according to the data to be transmitted.

In a further exemplary embodiment, a backlit LCD device may be configured to function as an optical data transmitter. In such an embodiment, one or more backlight sources may be configured with the additional function of transmitting the optical communication signals.

According to another exemplary embodiment, the LCD device may be capable of functioning as an optical data transceiver. Thus, the device may be configure to both receive and transmit optical communication signals through the LC layer. In such an embodiment, the LCD device may include one or more light sensors for sensing optical communication signals, and one or more optical transmitters for transmitting optical communication signals. Additional transceiver equipment may be provided for modulating and demodulating optical signals for encoding and decoding data in the optical signals.

Thus, according to various exemplary embodiments of the present invention, an LCD device is capable of a communication system in which the device performs data communications (unidirectional or bidirectional) with a remote communication device. Such a system may be implemented in specific applications. For instance, the system may be designed for an aircraft cockpit, where information is visually displayed to the pilot during normal vision mode, and transmitted to a communication unit in the pilot's helmet during night vision mode.

Further aspects in the scope of applicability of the present invention will become apparent from the detailed description provided below. However, it should be understood that the detailed description and the specific embodiments therein, while disclosing exemplary embodiments of the invention, are provided for purposes of illustration only.

### BRIEF DESCRIPTION OF THE DRAWINGS

A more complete understanding of the present invention will become apparent from the following description taken in conjunction with the accompanying drawings, which are given by way of illustration only and, thus, are not limitative of the present invention. In these drawings, similar elements are referred to using similar reference numbers, wherein:

FIGS. 1A and 1B illustrate the configuration of a typical liquid crystal display (LCD) device;

FIGS. 2A and 2B illustrate a particular arrangement of backlight sources in use in existing LCD devices, referred to as an LED edge-lit light guide assembly;

FIGS. 3A and 3B illustrate an alternative arrangement of backlight sources, utilizing a backlight panel on which LEDs are mounted;

FIG. 4 illustrates an LCD based communication device, which is configured to receive optical communication signals and extract data therefrom, according to an exemplary embodiment of the present invention;

FIGS. 5A and 5B illustrate the operation of an LCD based communication device, utilizing an LED edge-lit diffuser as a backlight source, according to an exemplary embodiment of the present invention;

FIGS. 6A and 6B illustrate the operation of another configuration of an LCD based communication device, utilizing a backlight panel on which LEDs are mounted, according to an exemplary embodiment of the present invention;

FIG. 7 illustrates an LCD based communication device, which is configured to transmit data-encoded optical communication signals, according to an exemplary embodiment of the present invention;

FIG. 8 illustrates an LCD based communication device configured as a transceiver of data-encoded optical communication signals, according to an exemplary embodiment of the present invention; and

FIGS. 9A and 9B illustrate a communication system for use in an aircraft cockpit, including an LCD based communication device configured to transmit data-encoded optical communication signals, according to an exemplary embodiment of the present invention.

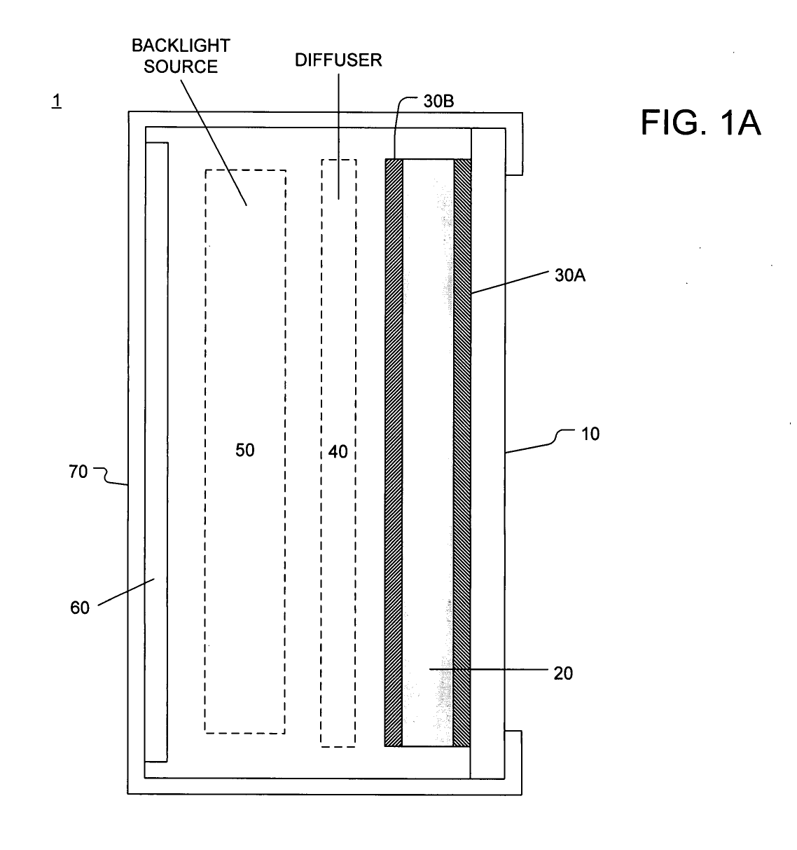

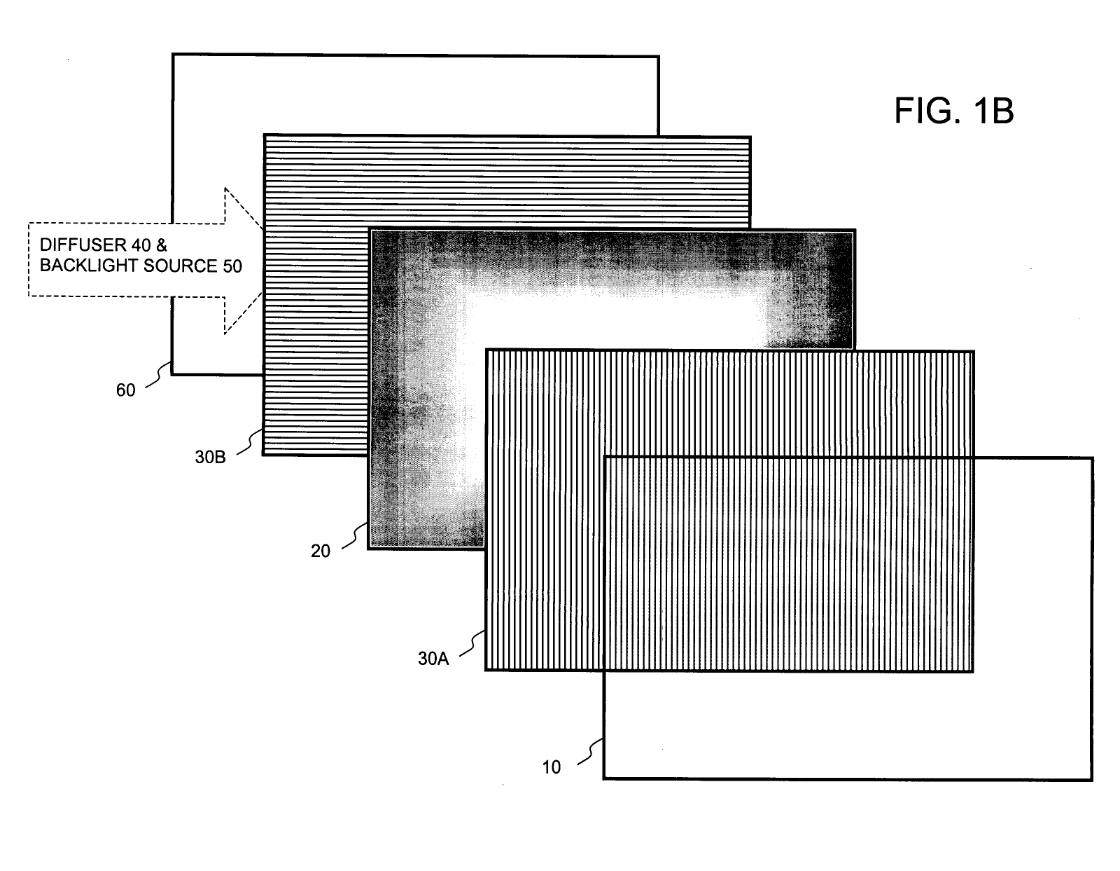

### DETAILED DESCRIPTION OF EXEMPLARY EMBODIMENTS

The present invention exploits the bidirectional nature of the liquid crystal (LC) cells in order to incorporate communication functions in a liquid crystal display (LCD) device. Furthermore, exemplary embodiments of the invention also use the controllability of certain types of backlight sources to transmit data, in addition to display images.

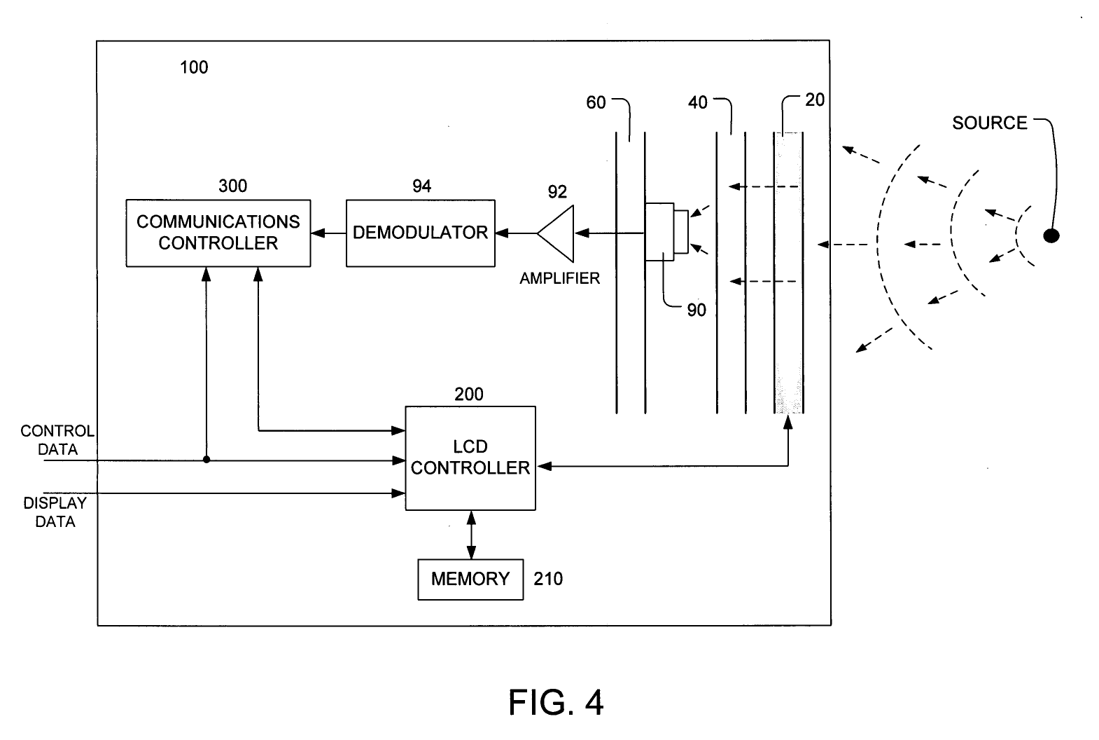

According to one aspect of the invention, FIG. 4 conceptually illustrates an LCD based communication device 100 configured to receive optical communication signals and extract data therefrom. In FIG. 4, an LCD based communication device 100 is equipped with one or more light sensing devices 90 in the LCD stack. For purposes of description, only the following layers of the LCD stack are shown: LC layer 20, diffuser 40, and reflective layer 60. However, other than the addition of light sensing device(s) 90, device 100 may take on any of a number of conventional LCD stack configurations. Also, device 100 includes an LCD controller 200 that may utilize conventional techniques for controlling each cell in LC layer 20 to a desired level of transmissivity. The LCD controller 200 may also be configured to control other aspects of the LCD stack (e.g., backlights). As shown in FIG. 4, the LCD controller 200 includes a memory 210 (e.g., for storing image frame data).

The light sensing device(s) 90 in FIG. 4 may be connected to equipment for processing the optical signals sensed by the light sensing device 90. Such equipment may include amplifiers 92, filters (not shown), and/or other equipment. FIG. 4 further shows that the processed optical signals are sent to the demodulator 94. A communications controller 300 is shown in FIG. 4 to receive demodulated signals from the demodulator 94. The communications controller 300 is also communicatively linked to the LCD controller 200.

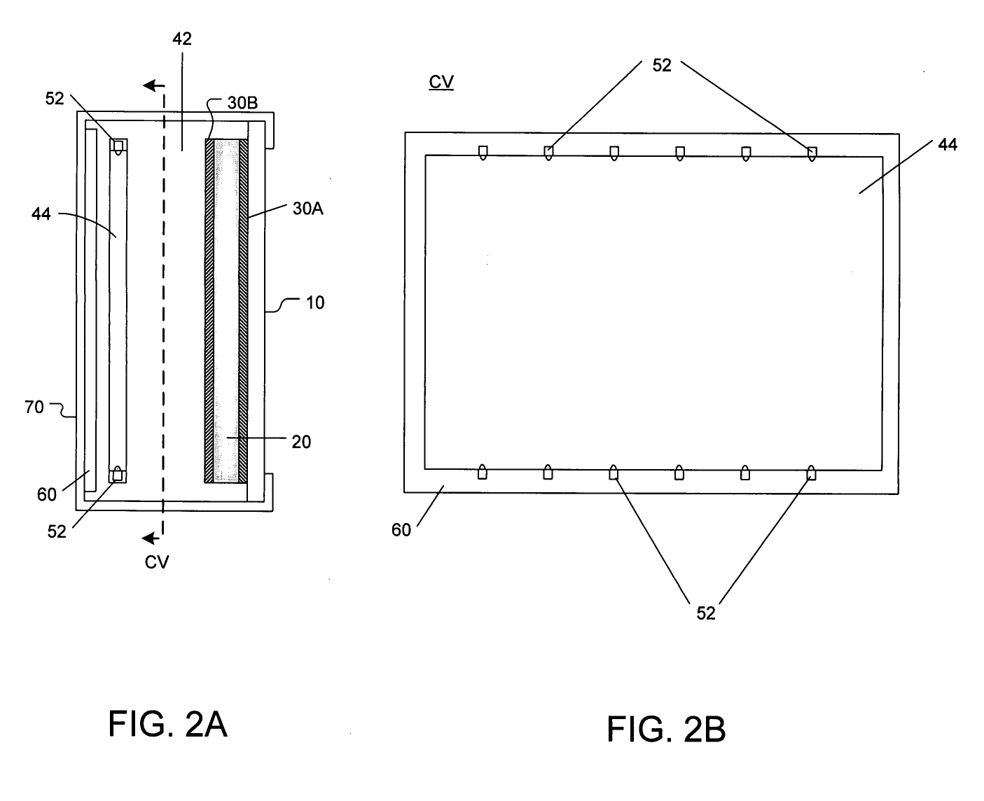

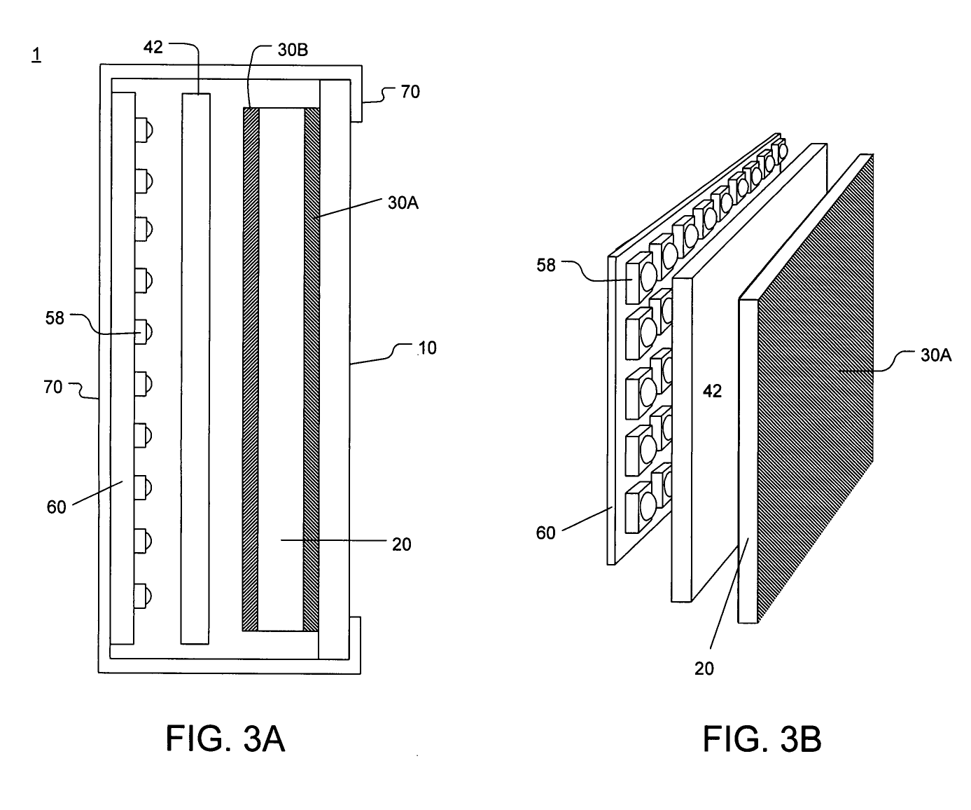

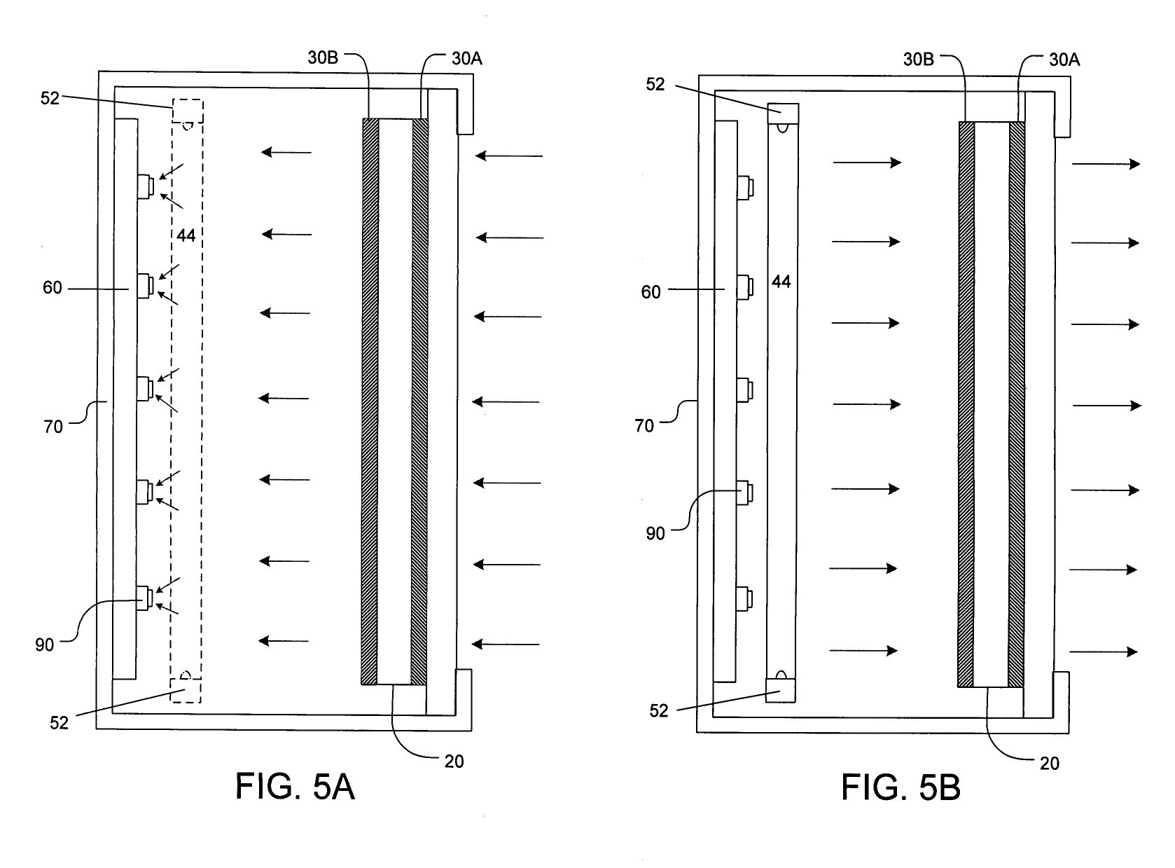

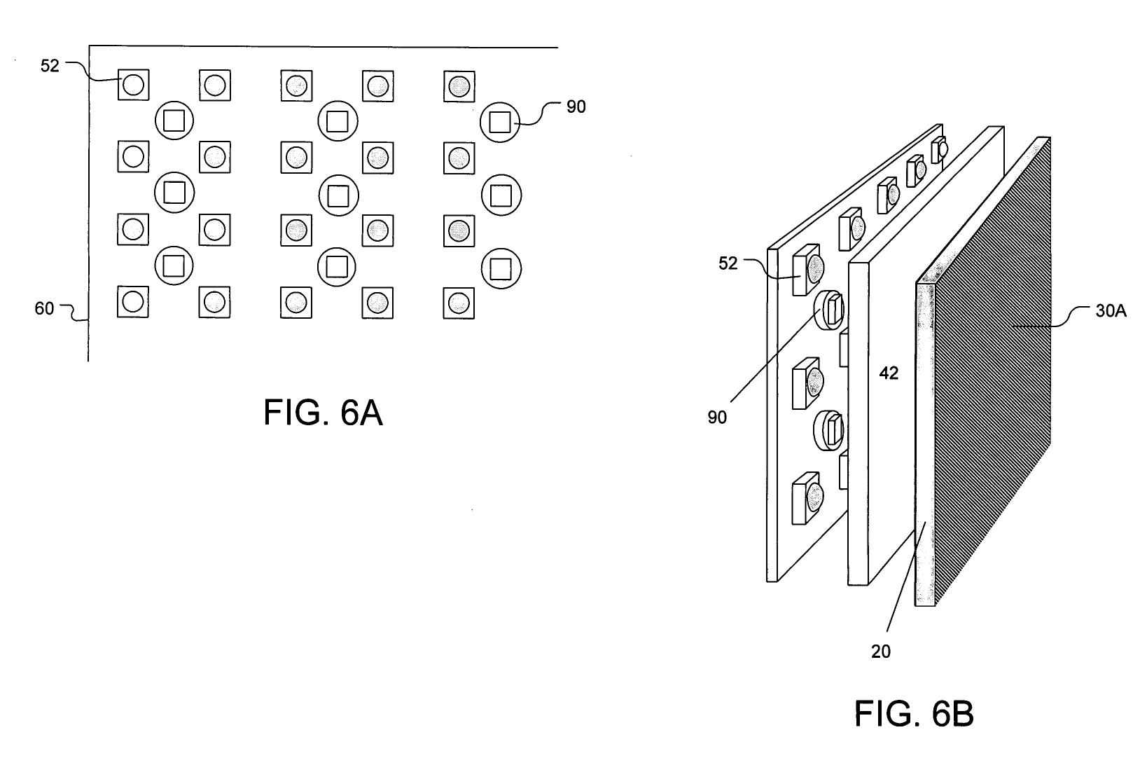

The light sensing device(s) 90 may be integrated with different types of backlight arrangements. Furthermore, the light sensing device(s) 90 may be dispersed in the backlight cavity of the LCD stack. For example, as shown in FIGS. 5A and 5B, a plurality of light sensing devices 90 are implemented in an LCD stack utilizing an light-emitting diode (LED) edge-lit light guide assembly (discussed above in connection with FIGS. 2A and 2B). In such an embodiment, the light sensing devices 90 may be mounted, e.g., on the reflective layer 60 as shown in FIGS. 5A and 5B. In an alternative configuration, as shown in FIGS. 6A and 6B, a plurality of light sensing devices 90 may be dispersed on the same backlight panel on which LEDs are mounted (as discussed above in connection with FIGS. 3A and 3B).

Of course, other implementations of the light sensing device(s) 90 and backlights are possible. Also, the present invention could be implemented using a reflective-type LCD stack, which does not require backlights.

Next, the operation of the LCD based communication device 100 in FIG. 4 will be described. As shown in this figure, device 100 may operate as a conventional LCD panel for displaying images. During such operation, the LCD controller 200 controls the LC cells in layer 20 to provide the necessary levels of transmissivity, according to received display data, in order to display the image.

However, the LCD controller 200 also controls the LC layer 20 to allow entry of optical communication signals into the LCD stack. For example, FIG. 4 shows optical communication signals being transmitted from a particular source (e.g., remote transmitter) toward the LCD based communication device 100. To receive these signals, the LCD controller 300 may control at least part of the LC layer 20 to permit passage of the optical communication signals therethrough, to be sensed by the light sensing device(s) 90.

For example, the LC layer 20 may be configured to receive optical communication signals periodically, e.g., during “dark” periods. Specifically, these dark periods are portions of the system clock period when image display is not being performed and, thus, the backlights (if any) are turned off. This has the advantage of helping the light sensing device(s) 90 discriminate between optical communication signals and backlight. Also, this helps prevent the image update operation of the LC layer 20 from interfering with the function of passing through optical communication signals.

As an example, FIG. 5A shows a portion of a system clock period when the LCD based communication device 100 is configured to receive optical communication signals. Thus, in FIG. 5A, the LC layer 20 is operative to allow the optical communication signals to pass through, and the light sensing devices 90 to sense the optical communication signals. Also, in FIG. 5A, the backlight sources are turned off (in this case, an LED edge-lit light guide assembly is inoperative). FIG. 5B illustrates another portion of the system clock period when the image is being updated, while the light sensing devices 90 are inoperative. Of course, the dark periods, when optical communication signals are received and sensed, should be short enough that they are imperceptible to the user.

In order to increase the ability of the light sensing device(s) 90 to discriminate between optical communication signals and backlight, the optical communication signals may be generated by infrared (IR) sources. Also, the optical communication signals may be generated according to a data protocol where data is sent via the optical communication signals in bursts. Accordingly, the communications controller 300 would be designed to extract data according to a burst data protocol.

However, it is also possible to perform the image update operation at the same time as receiving the optical communication signals. For instance, as described above, the optical communication signals may be generated by an IR source, and the light sensing device(s) 90 may be designed only to sense such IR signals. Thus, the light sensing device(s) 90 would be able to discriminate backlight and optical communication signals. Further, one or more small portions of the LC layer 20 may be dedicated to allowing the optical communication signals to pass through to the light sensing device(s), while the remainder of the LC layer 20 performs image display.

After the optical communications signals are sensed, they may be processed, e.g., amplified and/or filtered, and sent to the demodulator 94. The demodulated signals are then sent to the communications controller 300, which is capable of extracting the data. The data may then be sent to another data processor (not shown), processed by the communications controller 300 itself, or used to help control the LCD controller 200. Since the communications controller 300 and LCD controller 200 are linked, their operations may be synchronized. Thus, if data is to be received during dark periods of the LCD stack, the communications controller 300 is able to synchronize its operations with the reception of optical communication signals.

It should be noted that, with multiple light sensing devices 90 being present in the LCD stack, it may be possible to configure the LCD based communication device 100 to receive data from multiple communication channels. In other words, different light sensing devices 90 may sense optical communication signals corresponding to different communication channels. The difference among channels may consist in differences in amplitude, frequency, phase, and/or time slot. The channels may differ in other aspects as well.

The embodiment illustrated in FIG. 4 specifically describes the operations LCD based communication device 100 as a data receiver. According to another aspect of the present invention, the LCD based communication device 100 may operate as a data transmitter.

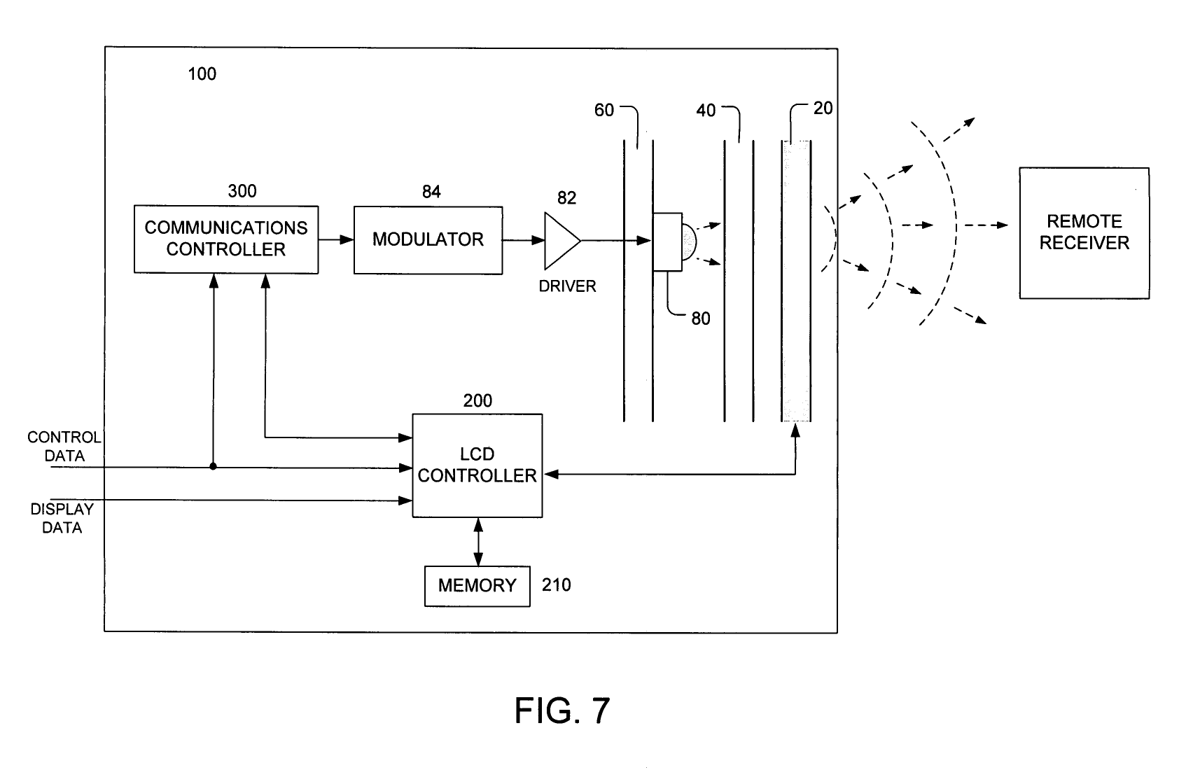

FIG. 7 illustrates a configuration of an LCD based communication device 100 for transmitting data-encoded optical communication signals. In this figure, the device 100 contains an LCD stack, which performs image display according to conventional techniques. Thus, even though only the LC layer 20, diffuser 40, and reflective layer 60 are shown, the LCD stack of FIG. 7 may include other conventional layers and elements in LCD panels. Further, FIG. 7 illustrates an LCD controller 200 linked to the LCD stack to control the LC layer 20, i.e., to set the LC cells to desired levels of transmissivity, and to control any other aspects (e.g., backlights) of operation in the LCD stack as necessary.

However, FIG. 7 shows at least one optical transmitter light source 80 implemented in the LCD stack. Also, FIG. 7 illustrates a communications controller 300, which is connected to a modulator 84 and signal driver circuitry 82 (e.g., amplifier).

The operation of the device 100 in FIG. 7 will now be described. The communications controller 300 may receive control data indicating what data is to be transmitted to a remote receiver. The communications controller 300 is designed to encode the data into optical communications signals, i.e., by controlling the modulator 84 to modulate the data onto a carrier frequency. This carrier frequency should be above the critical flicker frequency of the LCD stack. The modulated signals are amplified by the signal driver circuitry 82 to be transmitted as optical communication signals by the optical transmitter(s) 80.

Given a sufficiently fast LCD panel, the LCD controller 200 may turn on and off sections of the LC layer 20 to provide the necessary modulation of the signal. In this case, it would not be necessary to include the modulator 84 in the device 100.

The LCD controller 200 controls the LC layer 20 to allow passage therethrough for the optical communication signals transmitted by optical transmitter(s) 80. Thus, the operations of the LCD controller 200 are synchronized to communications controller 300.

As discussed to some degree in connection with FIG. 4, the operation of the LCD based communication device 100 as a communicator should not interfere with the operation of the device 100 as an LCD display. Thus, in the configuration of FIG. 7, the optical transmitter(s) 80 may be designed to transmit IR communication signals, so that they will not be noticed by the users/viewers.

As an alternative to transmitting in IR range, the optical communication signals may be transmitted in short bursts (short enough not to be noticed by the viewer). Accordingly, the communications controller 300 and modulator 84 may be designed to operate according to a bursty data communication protocol. Similarly, the LCD controller 200 controls the LC layer 20 to allow passage during these data bursts periods.

According to an exemplary embodiment, the optical transmitter(s) 80 may be dispersed somewhere in a backlight cavity of the LCD stack. For example, the LCD stack may have a backlight arrangement similar to FIGS. 2A and 2B described above (i.e., an LED edge-lit light guide assembly). In such an embodiment, the optical transmitter(s) 80 may be mounted, e.g., on the reflective layer 60. Alternatively, the optical transmitter(s) 80 may be mounted on an LED backlight panel, as illustrated in FIGS. 3A and 3B.

In an exemplary embodiment, the optical transmitters 80 may be the same light sources as those used for the backlight of the LCD stack. In other words, an optical transmitter light source 80 may have the dual function of transmitting optical communication signals (during “data transmit” periods), and transmitting backlight to display images (during image display/update periods). For example, referring to FIG. 3A, one or more of the LEDs 58 in the backlight panel may have the additional function of transmitting optical communication signals, encoded with data by the communications controller 300 and modulator 84.

Similar to the configuration of FIG. 4, the LCD based communication device 100 in FIG. 7 may utilize multiple communication channels. Specifically, different optical transmitters 80 in the LCD stack may be configured to optically transmit data on different communication channels. For example, the transmitted optical communication signals may differ in amplitude, frequency, phase, time slot, and/or other characteristics in order to implement different communication channels.

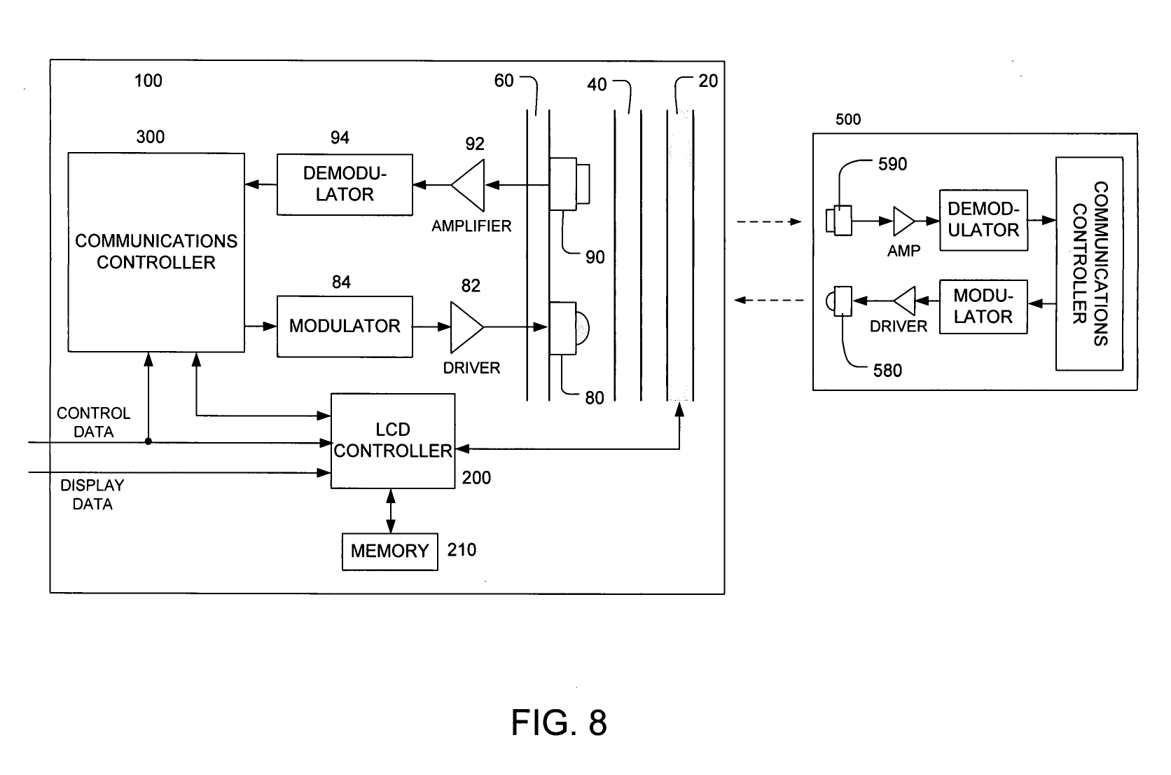

According to a further aspect of the present invention, an LCD based communication device 100 may be designed to both transmit and receive data via optical communication signals. For example, FIG. 8 illustrates a configuration in which the LCD based communication device 100 is designed as a transceiver of data-encoded optical communication signals.

Basically, FIG. 8 shows how elements of FIGS. 4 and 7 may be combined to produce an LCD based communication device 100 capable of transmitting and receiving data via the LCD stack. Since many of these elements have been described earlier in connection with FIGS. 4 and 7, a detailed description need not be repeated here.

However, FIG. 8 also shows a remote communication device 500, with which the LCD based communication device 100 may communicate or exchange data. This remote communication device 500 may be similarly equipped with a communications controller and a modulator and demodulator, as well as one or more optical transmitter light sources 580 and light sensing devices 590.

Thus, in order to transmit data to the LCD based communication device 100, the remote communication device 500 may be configured to modulate the data into one or more optical communication channels, which are programmed for reception by device 100, and transmit the corresponding optical communication signals via optical transmitter(s) 580. Further, to receive data from the LCD based communication device 100, the remote communication device 500 senses the optical communication signals via light sensing device(s) 590, demodulates the received signals, and extracts data therefrom.

Of course, the remote communication device 500 may simply be designed for either data transmission or reception. For instance, it may be a remote control for a device 100 configured as an LCD based television. As another example, assuming that device 100 is used as an LCD computer monitor, the remote communication device 500 could be a personal digital assistant (PDA), or a type of portable storage device, for receiving data transfers from a computer. On the other hand, it is possible for the remote communication device to be another LCD based communication device 100.

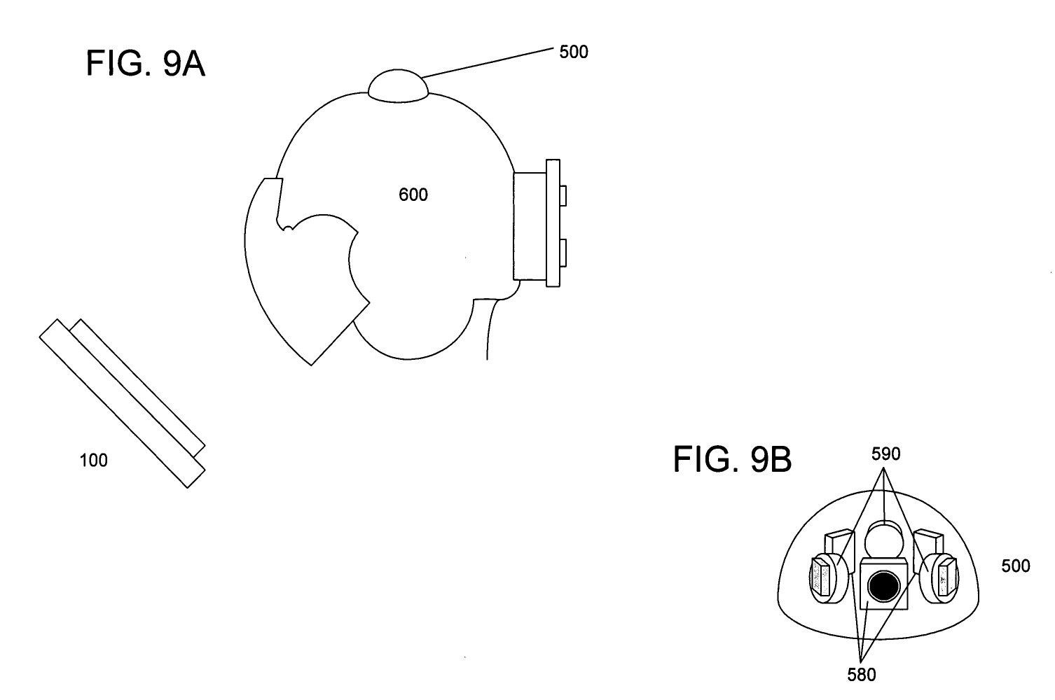

As touched on above, various applications are possible for the LCD based communication device 100. One particular type of application might be an aircraft cockpit communication system, configured for both normal vision mode and night vision mode. FIGS. 9A and 9B illustrate an example of communication system in an aircraft cockpit, using an LCD based communication device 100 for transmitting data-encoded optical communication signals.

As shown in FIG. 9, the pilot may wear a helmet 600 equipped with a remote communication device 500, equipped to receive optical communication signals from the LCD based communication device 100.

For instance, during normal vision mode, device 100 may be operated as a normal LCD display in order to display images to the pilot to convey information. However, at night, the aircraft may be operated in a covert, night vision mode. In the night vision mode, the exterior and interior lighting of the aircraft may be limited to the infrared (IR) range. Accordingly, in night mode, the pilot may need special visors to view flight data (e.g., navigation signals, etc.) as well as other information. Also, in night mode, device 100 may switch from normal image display (i.e., normal vision mode) to a night vision mode to maintain covertness.

Accordingly, in night vision mode, the LCD based communication device 100 transmits information to the remote communication device 500 on helmet 600. As shown in FIG. 9B, the remote communication device 500 has light sensing devices 590 for receiving this data. Such data may be displayed to the pilot via the special visors.

The remote communication device 500 may also be configured to transmit information to the LCD based communication device 100 in FIG. 9. For example, the remote communication device 500 may transmit data of the pilot's identity to device 100, in order to receive information tailored to that pilot.

Various other applications are possible for the present invention, as will be readily contemplated by those of ordinary skill in the art. For example, the principles of the invention may be used for configuring an LCD display panel with an ambient light detector, e.g., for adjusting brightness of the image display. Another possible use of the present invention is as a visual or IR data port for LCD based televisions or computer monitors.

Exemplary embodiments having been described above, it should be noted that such descriptions are provided for illustration only and, thus, are not meant to limit the present invention as defined by the claims below. Any variations or modifications of these embodiments, which do not depart from the spirit and scope of the present invention, are intended to be included within the scope of the claimed invention.

What is claimed is:

1. A liquid crystal display (LCD) device comprising:
a liquid crystal (LC) layer configured to control the passage of light therethrough in order to display images; and
a light sensing device configured to sense optical communication signals, which are received through the LC layer,
wherein the light sensing device is operably connected to a communications controller, which is configured to extract data from the sensed optical communication signals.

2. The LCD device of claim 1, further comprising:
a demodulator unit operably connected to the light sensor to receive and demodulate the sensed optical communication signals,
wherein the communications controller extracts data from the demodulated optical communications signals.

3. The LCD device of claim 1, further comprising:
a backlight panel on which one or more backlight sources are mounted,
wherein the light sensing device includes one or more light sensors mounted on the backlight panel.

4. The LCD device of claim 3, wherein the one or more light sensors are operated in the infrared (IR) frequency range.

5. A communication system comprising the LCD device of claim 1 and a remote communication device, wherein the remote communication device is configured to transmit optical communication signals encoded with data to the LCD device.

6. The communication system of claim 5, wherein the LCD device is configured for dual modes of operation including:
a first mode for displaying data to a user; and
a second mode for receiving data from the remote communication device via the optical communication signals.

7. The LCD device of claim 1, further comprising:
at least one optical transmitter configured to transmit optical communication signals through the LC layer,
wherein the communications controller is configured to encode data into the optical communication signals to be transmitted.

8. A liquid crystal display (LCD) device comprising:
a liquid crystal layer configured control the passage of light therethrough in order to display images; and
at least one optical transmitter configured to transmit optical communication signals through the LC layer,
wherein the at least one optical transmitter is operably connected to a communications controller, which is configured to encode data into the optical communication signals to be transmitted.

9. The LCD device of claim 8, wherein the optical transmitter light source is configured for dual functions of:
transmitting the optical communication signals, and
operating as a backlight source for displaying the images.

10. The LCD device of claim 9, wherein the communications controller is configured to perform bursty data transmissions via the optical transmitter.

11. The LCD device of claim 9, wherein the optical transmitter is a light-emitting diode (LED).

12. The LCD device of claim 8, further comprising:
a modulator configured to modulate the optical communication signals to be transmitted by the optical transmitter,
wherein the modulator is controlled by the communications controller to encode data into the optical communication signals to be transmitted.

13. The LCD device of claim 8, wherein the optical transmitter is configured to transmit the optical communication signals in the infrared (IR) frequency range.

14. A communication system comprising the LCD device of claim 8 and a remote communication device, wherein the remote communication device is configured to receive the optical communication signals from the LCD device and extract data from the received optical communication signals.

15. The communication system of claim 14, wherein the LCD device is configured for dual modes of operation including:
a first mode for displaying data to a user; and
a second mode for transmitting data to the remote communication device via the optical communication signals.

16. A liquid crystal display (LCD) device comprising:
a liquid crystal (LC) layer configured to control the passage of light therethrough in order to display images;
a light sensing device configured to sense optical communication signals, which are received through the LC layer; and
at least one optical transmitter configured to transmit optical communication signals through the LC layer,
wherein the light sensing device and at least one optical transmitter are operably connected to a communications controller, which is configured to extract data from the sensed optical communication signals and encode data into the optical communication signals to be transmitted.

17. The LCD device of claim 16, further comprising:
a demodulator unit operably connected to the light sensor to receive and demodulate the sensed optical communication signals,
wherein the communications controller extracts data from the demodulated optical communications signals.

18. The LCD device of claim 16, further comprising:
a modulator configured to modulate the optical communication signals to be transmitted by the optical transmitter,
wherein the modulator is controlled by the communications controller to encode data into the optical communication signals to be transmitted.

19. The LCD device of claim 16, wherein the one or more light sensors and the at least one optical transmitter are operated in the infrared (IR) frequency range.

20. A communication system comprising the LCD device of claim 16 and a remote communication device, wherein the remote communication device is configured to perform at least one of the following:
transmit optical communication signals to the LCD device, and
receive and extract data from optical communication signals transmitted by the LCD device.
